(19) United States
(12) Patent Application Publication
(10) Pub. No.: US 2026/0120299 A1
(43) Pub. Date: Apr. 30, 2026

(54) METHOD AND APPARATUS FOR ESTIMATING MULTI-STATE CONSTRAINT KALMAN FILTER BASED RGB-D VISUAL-INERTIAL ODOMETRY WITH SPLINE INTERPOLATION AND NONHOLONOMIC CONSTRAINT

(71) Applicant: Twinny Co., Ltd., Daejeon (KR)

(72) Inventors: Kwangyilk JUNG, Sejong (KR); Jae Bong SONG, Daejeon (KR); Samwoo SEONG, Daejeon (KR)

(73) Assignee: Twinny Co., Ltd., Daejeon (KR)

(21) Appl. No.: 19/150,916

(22) PCT Filed: May 19, 2025
(86) PCT No.: PCT/KR2025/006753

§ 371 Date: Jul. 25, 2025

(30) Foreign Application Priority Data
May 23, 2024 (KR) 10-2024-0067423

(51) Int. Cl. G06T 7/277; G05D 1/243; G05D 1/245; G06T 7/246; G06T 7/50; G06T 7/70

(52) U.S. Cl. CPC G06T 7/277; G05D 1/243; G05D 1/245; G06T 7/248; G06T 7/50; G06T 7/70; G06T 2207/10024; G06T 2207/10028; G06T 2207/30241; G06T 2207/30244; G06T 2207/30252

(57) ABSTRACT

A method and apparatus for estimating a multi-state constraint Kalman filter (MSCKF) based RGB-D visual-inertial odometry with a spline interpolation and a nonholonomic constraint (NHC) is provided. The method includes calculating a state variable of the MSCKF through the spline interpolation representing a trajectory of a mobile robot over time, and estimating an updated RGB-D visual-inertial odometry using the nonholonomic constraint (NHC) and a zero-velocity update (ZUPT) in the mobile robot equipped with a depth camera and an inertial sensor mounted thereon.

### CROSS REFERENCE TO THE RELATED APPLICATIONS

This application is the national phase entry of International Application No. PCT/KR2025/006753, filed on May 19, 2025, which is based upon and claims priority to Korean Patent Application No. 10-2024-0067423, filed on May 23, 2024, the entire contents of which are incorporated herein by reference.

### TECHNICAL FIELD

The present disclosure relates to a method and apparatus for estimating a multi-state constraint Kalman filter (MSCKF) based RGB-D visual-inertial odometry with a spline interpolation and a nonholonomic constraint (NHC), more particularly, the present disclosure relates to a method and apparatus for calculating a state variable prediction value of the MSCKF using the spline interpolation, and estimate an improved visual-inertial odometry through the nonholonomic constraint (NHC) and zero-velocity update (ZUPT) in a differential-wheeled mobile robot equipped with a depth camera and an inertial sensor.

### BACKGROUND

Accurate localization for recognizing a position of a mobile robot for autonomous driving of the mobile robot is an essential technique.

The localization or simultaneous localization and mapping (SLAM) requires that the mobile robot may accurately estimate a change in its relative position in real time. Accordingly, to measure or calculate a change in the relative position of the mobile robot, various sensors such as an inertial measurement unit (IMU), wheel encoder, LiDAR, and camera may be used. The camera includes a monocular camera, a stereo camera, and a depth camera, and estimating the motion of the camera or the apparatus equipped with the camera using visual information captured by the camera is referred to as visual odometry (VO).

However, in environments with varying lighting conditions or numerous dynamic objects, the visual information captured by the camera may become unreliable, leading to degraded performance of the visual odometry. To solve this, the odometry may be estimated by combining various sensors having different characteristics from the camera. The combination of the camera and the inertial measurement unit (IMU) is a representative example, and is referred to as a visual-inertial odometry (VIO) or a visual-inertial navigation system (VINS). The IMU is an apparatus for measuring acceleration and angular velocity, and may represent a motion of a sensor or an apparatus having the sensor attached thereto regardless of a change in a surrounding environment. However, the IMU has a characteristic that an error is accumulated when the IMU operates for a long time due to noise and bias of a measurement value. Accordingly, the VIO or VINS system in which the two sensors are coupled allows the two sensors to mutually compensate for disadvantages of each other, enabling accurate visual-inertial odometry (VIO) in various environments.

To estimate the visual odometry, 3D position information of a feature point acquired through the camera needs to be computed, which requires estimating the distance (depth) between the camera and the feature point. In the case of the monocular camera or the stereo camera, the distance to the feature point may be estimated by using multiple images acquired from the camera and exploiting a difference in pixel coordinates where the same feature point is projected onto the multiple images. In the case of the depth camera, since the depth information of a point corresponding to an image pixel is provided together, allowing the distance to the feature point to be acquired without additional calculation.

The present disclosure may be applied to the implementation method of a multi-state constraint Kalman filter (MSCKF), which is one of the various conventional approaches to the VIO. The conventional visual simultaneous localization and mapping (V-SLAM) method using the camera information enables accurate state estimation by using a method of storing all observed coordinates of the feature point, but this requires large storage capacity and may lead to increased calculation time. To solve this, the MSCKF-based VIO may reduce the number of state variables to be estimated in real time by using the position information of the camera observing the feature point as the state variable instead of the feature point information itself, and may perform accurate state estimation by considering the correlation between the camera key frames as the state variables.

The MSCKF-based VIO may model the motion equation of the IMU having a relatively fast cycle compared to the camera, and may compute the acceleration and angular velocity data of a moving body frame (or mobile robot) acquired by the IMU as a 3D position and pose (rotation) (pre-integration). For example, the motion of the moving body frame between two different camera frames is predicted by the measurement value of the IMU and the motion model, and the optimal state variable is updated by acquiring the difference between the measurement value and prediction value based on the information of the feature point acquired by the camera. The accuracy and velocity of the IMU pre-integration have a great influence on the overall reliability and efficiency of the VIO algorithm because the measurement value of the IMU is used to determine the 3D position of the feature point as well as predicting the motion of the moving body frame for a short time.

When the odometry is estimated using the measurement value from sensors such as the camera and IMU, sensor noise may lead to inaccurate odometry for a shout time. When these combined sensors are installed on the mobile robot, the inherent motion characteristics of the robot may be leveraged to correct the result of the VIO. In such cases, a constraint based on a limited degree of freedom of the body frame is referred to as a nonholonomic constraint.

For a differential-wheeled mobile robot, due to its ground-constrained motion characteristics, movement in the direction perpendicular to the ground, as well as movement along the robot's y-axis in its body frame, is restricted. If the VIO estimates movement along these constrained directions, virtual measurement value may be introduced to restrict the state estimation in the MSCKF, thereby making the system more robust to sensor disturbances and producing the VIO estimates that better reflect the true motion of the mobile robot. Additionally, when the mobile robot is stationary, noise in the IMU measurement value may still lead to incorrect predictions of the motion of the mobile robot through pre-integration. In such cases, if the mobile robot is judged to be stationary, a virtual measurement value indicating that the velocity is zero may be used to constrain the MSCKF state estimation, and thus this approach is referred to as zero-velocity update (ZUPT).

### SUMMARY

### Technical Problem

An object to be solved in the present disclosure is to propose a localization algorithm capable of being operated in real time based on a multi-state constraint Kalman filter (MSCKF), incorporating the concept of an error-state Kalman filter (ESKF).

An object to be solved in the present disclosure is to provide a depth-based visual-inertial odometry (DVIO) using inverse depth information as a filter measurement value using a depth camera based on the structure of the MSCKF. In this case, the present disclosure may increase the stability of the system by converting the depth information into the inverse depth information, thereby replacing a value of a pixel measured as an infinite distance from a depth camera to an object with 0, and may model an uncertainty of the inverse depth measurement value as a constant value, and thus provide a VIO having improved performance in terms of mathematical characteristics of the MSCKF.

Another object to be solved in the present disclosure is to calculate a prediction value of a state variable of the MSCKF with a spline interpolation. If the spline interpolation is used for a time and a position of a plurality of camera key frames in the past, a trajectory of the mobile robot over time may be modeled in a polynomial. In this case, the present disclosure may improve the prediction value of the state variable of the MSCKF through the spline interpolation by adding a velocity vector acquired from the latest key frame as a boundary condition of the spline interpolation.

Yet another object to be solved by the present disclosure is to provide a visual-inertial odometry that leverages a depth camera and an IMU mounted on a differential-wheeled mobile robot to estimate odometry while satisfying a nonholonomic constraint inherent to the robot's driving characteristics, and thus this approach enhances robustness against disturbances in the measurement value. Additionally, by detecting when the mobile robot is stationary and applying corresponding constraint to the state estimation, the present disclosure may provide more accurate visual-inertial odometry results during stationary periods.

However, the technical problems to be solved by the present disclosure are not limited to the above technical problems, and may be expanded in various ways without departing from the technical spirit and the scope of the present disclosure.

### Solution to Problem

A method for estimating a multi-state constraint Kalman filter (MSCKF) based RGB-D visual-inertial odometry with a spline interpolation and a nonholonomic constraint (NHC) performed by a computer according to an embodiment of the present disclosure includes calculating a state variable of the MSCKF through the spline interpolation representing a trajectory of a mobile robot over time, and estimating an updated RGB-D visual-inertial odometry using the nonholonomic constraint (NHC) and a zero-velocity update (ZUPT) in the mobile robot equipped with a depth camera and an inertial sensor mounted thereon.

An apparatus for estimating a multi-state constraint Kalman filter (MSCKF) based RGB-D visual-inertial odometry with a spline interpolation and a nonholonomic constraint (NHC) according to an embodiment of the present disclosure includes a calculator configured to calculate a state variable of the MSCKF through the spline interpolation representing a trajectory of a mobile robot over time, and an estimator configured to estimate an updated RGB-D visual-inertial odometry using the nonholonomic constraint (NHC) and a zero-velocity update (ZUPT) in the mobile robot equipped with a depth camera and an inertial sensor mounted thereon.

### Advantageous Effects of Invention

According to an embodiment of the present disclosure, in estimating the MSCKF-based visual-inertial odometry, the accuracy of the visual-inertial odometry may be improved by modeling the uncertainty of the inverse depth information by converting the depth information of the feature point acquired through the depth camera into inverse depth information and using the inverse depth information as an additional measurement value.

According to an embodiment of the present disclosure, the MSCKF state variable for the position and pose of the mobile robot may be predicted by using the spline interpolation using the historical position of the mobile robot and the real-time velocity vector of the mobile robot calculated from IMU, and errors in the visual feature-based filter update process may be reduced, and motion estimation similar to the true motion of the mobile robot may be performed.

According to an embodiment of the present disclosure, the nonholonomic constraint and zero-velocity update for the differential-wheeled mobile robot are applied to the visual-inertial odometry estimated through the MSCKF, and thus the visual-inertial odometry may be strong to disturbance of the sensor measurement value and similar to the true motion of the mobile robot.

However, the effects of the present disclosure are not limited to the above effects, and may be expanded in various ways without departing from the technical spirit and the scope of the present disclosure.

### BRIEF DESCRIPTION OF THE DRAWINGS

FIG. 1 is a block diagram of a system for estimating a MSCKF-based RGB-D visual-inertial odometry with a spline interpolation and nonholonomic constraint according to an embodiment of the present disclosure.

FIG. 2 is a flowchart illustrating an operation of a visual-inertial odometry estimation method according to an embodiment of the present disclosure.

FIGS. 3A to 3C are diagrams illustrating the effect of a spline interpolation and a velocity boundary condition on the stability of pose estimation according to an embodiment of the present disclosure.

FIG. 4 is a diagram illustrating the alignment defect between a body frame and an IMU frame of the mobile robot according to an embodiment of the present disclosure.

FIG. 5 is a block diagram illustrating a detailed configuration of a visual-inertial odometry estimation apparatus according to an embodiment of the present disclosure.

### DETAILED DESCRIPTION OF THE EMBODIMENTS

Advantages and features of the present disclosure, and methods for achieving them will become apparent by reference to the embodiments described in detail below with reference to the accompanying drawings. However, the present disclosure is not limited to the embodiments disclosed below, but may be implemented in various forms different from each other, and the embodiments are provided so that the disclosure of the present disclosure is thorough and complete, and the scope of the present disclosure is fully known to those skilled in the art to which the present disclosure pertains, and the present disclosure is defined only by the scope of the claims.

The terminology used in the specification is for the purpose of describing the embodiments and is not intended to limit the present disclosure. In the specification, the singular forms “a”, “an” and “the” are intended to include the plural forms as well, unless the context clearly indicates otherwise. As used in the specification, “comprises” and/or “comprising” does not exclude the presence or addition of one or more other element components, steps, operations, and/or elements.

Unless otherwise defined, all terms (including technical and scientific terms) used in the specification may be used in the sense that can be commonly understood by those skilled in the art to which the present disclosure pertains. Additionally, terms defined in commonly used dictionaries are not to be interpreted ideally or excessively unless explicitly and specifically defined otherwise.

Hereinafter, preferred embodiments of the present disclosure will be described in detail with reference to the accompanying drawings. The same reference numerals are used for the same elements on the drawings, and redundant descriptions of the same elements will be omitted.

Hereinafter, in embodiments, a method and apparatus for estimating a multi-state constraint Kalman filter (MSCKF) based RGB-D visual-inertial odometry with a spline interpolation and a nonholonomic constraint (NHC) will be described (hereinafter, referred to as a visual-inertial odometry estimation method and apparatus). The visual-inertial odometry estimation method may be performed by the visual-inertial odometry estimation apparatus that is a computer apparatus including a processor, and the visual-inertial odometry estimation apparatus may be driven under control of a computer program. The aforementioned computer program may be combined with the computer apparatus and stored in a computer-readable recording medium to execute the visual-inertial odometry estimation method on the computer apparatus. The computer program described herein may have a form of a separate program package, or may have a form in which a separate program package is pre-installed in the computer apparatus and is associated with an operating system or other program packages.

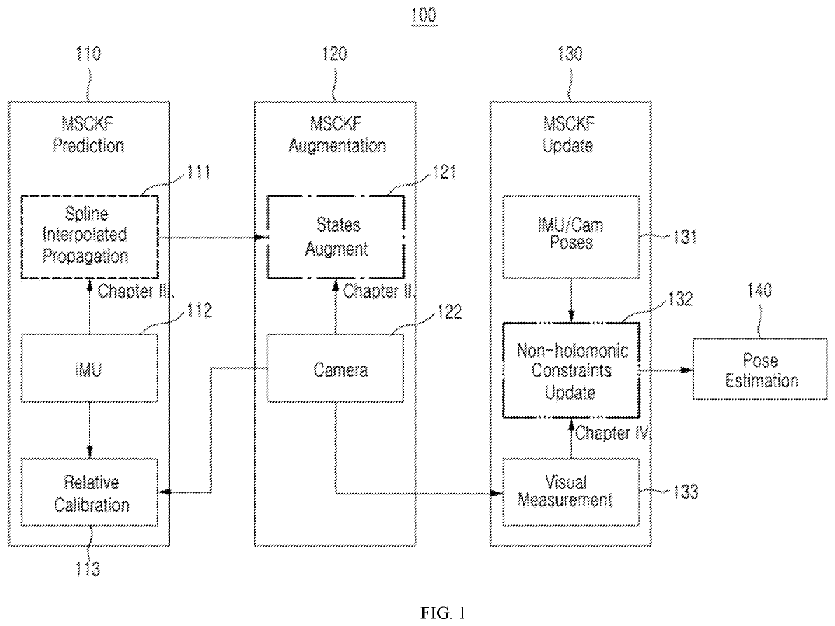

FIG. 1 is a block diagram of a system for estimating a MSCKF-based RGB-D visual-inertial odometry with spline interpolation and nonholonomic constraint according to an embodiment of the present disclosure.

The MSCKF-based RGB-D visual-inertial odometry estimation system (MSCKF-DVIO) 100 with spline interpolation and nonholonomic constraint according to an embodiment of the present disclosure performs a method for estimating visual-inertial odometry using a depth camera and an inertial measurement unit (IMU), and a method for updating the visual-inertial odometry estimation for a differential-wheeled mobile robot equipped with the depth camera and the IMU. The multi-state constraint Kalman filter (MSCKF) is a form of an extended Kalman filter (EKF) that estimates multiple state variables (such as IMU and camera states) simultaneously. For a typical Kalman filter (KF), only one state variable is estimated, but the multi-state constraint Kalman filter (MSCKF) takes into account several state variables together. Since the constraints between state variables should be satisfied, a more accurate localization is possible compared to the typical Kalman filter (KF). In addition, if a visual inertial odometry (VIO) calculates an odometry by fusing RGB information of visual sensor data and inertial sensor information, a depth aided visual inertial odometry (DVIO) is a localization technique of fusing RGB, depth, and inertial sensor information by adding depth information to compensate for RGB, depth, and inertial data. Compared to the VIO, the DVIO tends to be able to estimate a more robust localization in various situations in that depth information and inertial information are different in robust situations.

Referring to FIG. 1, the MSCKF-based RGB-D visual-inertial odometry estimation system 100 with the spline interpolation and the nonholonomic constraint according to an embodiment of the present disclosure performs pose estimation 140 through MSCKF prediction 110, MSCKF augmentation (or status variable expansion) 120, and MSCKF update 130.

The apparatus equipped with a depth camera and an inertial measurement unit (IMU) to estimate the RGB-D visual-inertial odometry is called a moving body frame (or a mobile robot). In this case, the depth camera may be an RGB-D camera, and the RGB-D image refers to an RGB and a depth image acquired from the camera. Further, the mobile robot may be a differential-wheeled mobile robot, and may include a depth camera, an inertial sensor, IMU, and CPU (computation apparatus).

The MSCKF-based RGB-D visual-inertial odometry estimation system 100 with the spline interpolation and the nonholonomic constraint according to the embodiment of the present disclosure is configured to represent a trajectory of the mobile robot over time estimated by the IMU 112 using the spline interpolation 111, and predict a real-time position and pose of the mobile robot and augment the state variable through the spline interpolation 111 (States Augment, 121).

At this time, the MSCKF-based RGB-D visual-inertial odometry estimation system 100 with the spline interpolation and the nonholonomic constraint according to the embodiment of the present disclosure is configured to calculate a position and pose of the camera 122 through the position and pose of the mobile robot, and calibrate relative variables by acquiring a correlation between the position and pose of the previous plurality of cameras 122 (Relative Calibration, 113).

Thereafter, the MSCKF-based RGB-D visual-inertial odometry estimation system 100 with the spline interpolation and the nonholonomic constraint according to the embodiment of the present disclosure is configured to update the state variable 131 by using the image pixel coordinates and the inverse depth information of the feature points acquired from the depth camera as the measurement value of the MSCKF (Visual Measurement, 133), and update the visual-inertial odometry 132 through the nonholonomic constraint and the zero-velocity update (ZUPT).

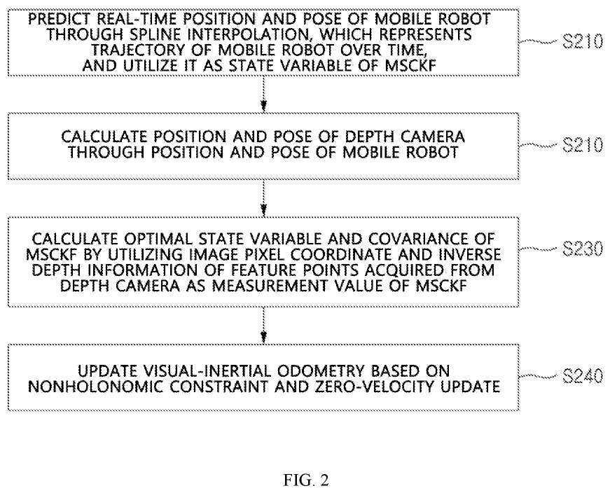

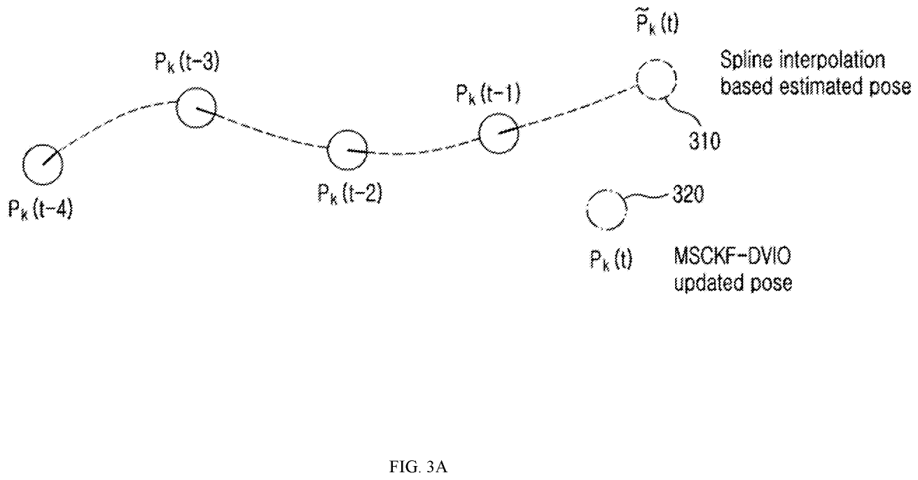

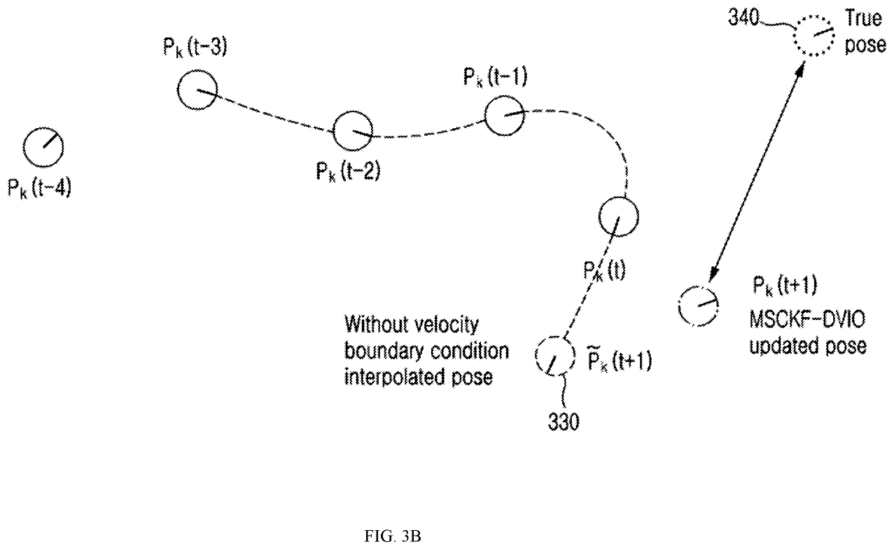

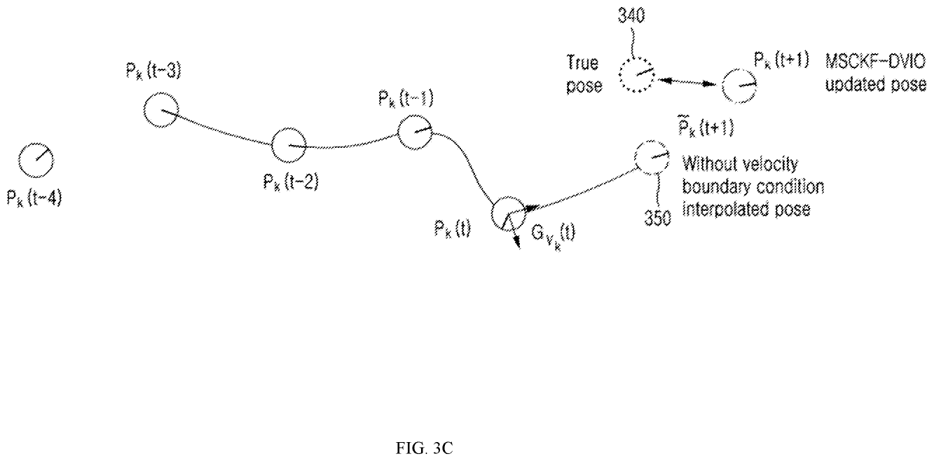

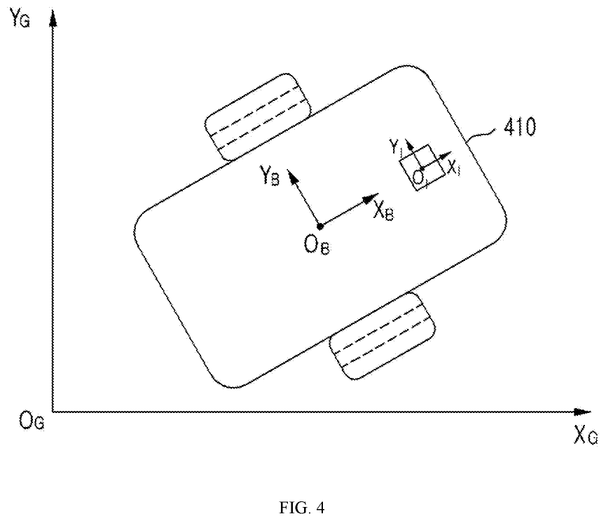

FIG. 2 is a flowchart illustrating an operation of a visual-inertial odometry estimation method according to an embodiment of the present disclosure. In addition, FIGS. 3A to 3C are diagrams illustrating the effect of a spline interpolation and a velocity boundary condition on the stability of pose estimation according to an embodiment of the present disclosure. In addition, FIG. 4 is a diagram illustrating the alignment defect between a body frame and an IMU frame of the mobile robot according to an embodiment of the present disclosure.

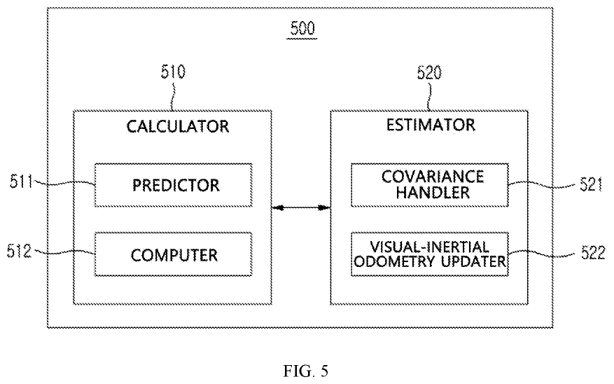

The method of FIG. 2 is performed by a visual-inertial odometry estimation apparatus 500 according to the embodiment of the present disclosure illustrated in FIG. 5.

Referring to FIG. 2, in step S210, the visual-inertial odometry estimation apparatus according to the embodiment of the present disclosure (more precisely, a calculator 510 of the visual-inertial odometry estimation apparatus 500 according to the embodiment of the present disclosure) is configured to calculate the state variable of the multi-state constraint Kalman filter (MSCKF) through the spline interpolation representing the trajectory of the mobile robot over time.

In step S210, the apparatus of the present disclosure may predict a real-time position and pose of the mobile robot through the spline interpolation and use the predicted real-time position and pose as the state variable of the MSCKF. More specifically, the velocity vector is computed using the position of the mobile robot and the measurement value of the IMU acquired in real time on a plurality of previous (or past) key frames is used, and the trajectory of the mobile robot over time may be represented by the spline interpolation, and thus the real-time position and pose of the mobile robot may be predicted and utilized as the state variable of the MSCKF.

FIG. 3A illustrates a spline interpolation based estimated pose 310 and the updated pose 320 in the MSCKF-DVIO based on visual measurement. FIG. 3B illustrates that when there is no velocity boundary condition in pose estimation based on the spline interpolation, the pose estimation 330 differs significantly from the true pose 340. FIG. 3C illustrates that by utilizing the velocity boundary condition in relation to the spline interpolation, the pose estimation 350 may obtain an approximation closer to the true pose 340.

As illustrated in FIG. 3C, in step S210, the apparatus of the present disclosure may represent the trajectory of the mobile robot over time by the spline interpolation using the position Pk of the mobile robot acquired from the plurality of previous key frames and the velocity vector Gvk estimated from the latest key frame in real-time as constraints. At this time, a real-time position and pose of the mobile robot at the prediction time may be predicted using the spline interpolation, and the predicted real-time position and pose of the mobile robot may be used as the relative variable prediction value of the MSCKF.

As described above, the apparatus of the present disclosure uses a spline interpolation considering the speed constraint compared to existing filters that do not use a spline interpolation, thereby reducing errors in a filter update process based on a visual feature and allowing motion estimation similar to an actual movement of the mobile robot.

In step S220, the visual-inertial odometry estimation apparatus according to the embodiment of the present disclosure (more precisely, a calculator 510 of the visual-inertial odometry estimation apparatus 500 according to the embodiment of the present disclosure) may calculate a position and pose of the depth camera through the position and pose of the mobile robot.

In step S220, the apparatus of the present disclosure may calculate the position and pose of the depth camera mounted on the mobile robot through the predicted real-time position and real-time pose of the mobile robot and derive a correlation between it and a previous position and pose of the depth camera.

The state variable of the MSCKF is represented as Equation 1 below.

$${{x}_{I} = {(}_{G}^{I} {{q}^{T}}^{G} {{v}_{I}^{T}}^{G} {{p}_{I}^{T}}_{C}^{I} {{q}^{T}}^{I} {p}_{C}^{T} )}^{T} \qquad [ Equation 1 ]$$

Here,

$${}_{G}^{I} q$$

represents a pose (rotation) of the IMU with respect to the global coordinate system, Gᵥ_{_{I}} represents a velocity of the IMU with respect to the global coordinate system, and Gₚ_{_{I}} represents a position of the IMU with respect to the global coordinate system. In addition,

$${}_{C}^{I} q$$

represents a pose (rotation) of the camera with respect to the IMU, and Iₚ_{_{C}} represents a position of the camera with respect to the IMU.

The error-state of the state variable is represented as Equation 2 below.

$${\hat{x}}_{I} = {( \begin{matrix}{}_{G}^{I} {\tilde{θ}}_{}^{T} & {}_{}^{G} {\tilde{v}}_{I}^{T} & {}_{}^{G} {\tilde{p}}_{I}^{T} & {}_{C}^{I} {\tilde{θ}}_{}^{T} & {}_{}^{I} {\tilde{p}}_{C}^{T}\end{matrix} )}^{T} \qquad [ Equation 2 ]$$

Here, the motion equation of the IMU is represented as Equation 3 below.

$${}_{G}^{I} {\dot{\hat{q}}}_{}^{} = \frac{1}{2} {Ω ( \hat{ω} )}_{G}^{I} \hat{q} , \\ {}^{G} \dot{\hat{v}} = {C ( {}_{G}^{I} \hat{q} )}^{T} \hat{a} + {}^{G} g , \\ {}_{}^{G} {\dot{\hat{p}}}_{I}^{} = {}^{G} \hat{v} , {}_{C}^{I} \dot{\hat{q}} = {0}_{3 \times 1} , {}_{}^{I} {\dot{\hat{p}}}_{C}^{} = {0}_{3 \times 1} \qquad [ Equation 3 ]$$

The motion equation of the error-state may be derived as Equations 4 and 5 through Equation 3.

$${\dot{\tilde{x}}}_{I} = F {\tilde{x}}_{I} + {Gn}_{I} \qquad [ Equation 4 ]$$

$$F = ( \begin{matrix}- ⌊ {\hat{ω}}_{\times } ⌋ & - {I}_{3} & {0}_{3 \times 3} & {0}_{3 \times 3} & {0}_{3 \times 3} \\ {0}_{3 \times 3} & {0}_{3 \times 3} & {0}_{3 \times 3} & {0}_{3 \times 3} & {0}_{3 \times 3} \\ - {C ( {}_{G}^{I} \hat{q} )}^{T} ⌊ {\hat{a}}_{\times } ⌋ & {0}_{3 \times 3} & {0}_{3 \times 3} & - {C ( {}_{G}^{I} \hat{q} )}^{T} & {0}_{3 \times 3} \\ {0}_{3 \times 3} & {0}_{3 \times 3} & {0}_{3 \times 3} & {0}_{3 \times 3} & {0}_{3 \times 3} \\ {0}_{3 \times 3} & {0}_{3 \times 3} & {I}_{3} & {0}_{3 \times 3} & {0}_{3 \times 3} \\ {0}_{3 \times 3} & {0}_{3 \times 3} & {0}_{3 \times 3} & {0}_{3 \times 3} & {0}_{3 \times 3} \\ {0}_{3 \times 3} & {0}_{3 \times 3} & {0}_{3 \times 3} & {0}_{3 \times 3} & {0}_{3 \times 3}\end{matrix} ) \\ G = ( \begin{matrix}- {I}_{3} & {0}_{3 \times 3} & {0}_{3 \times 3} & {0}_{3 \times 3} \\ {0}_{3 \times 3} & {I}_{3} & {0}_{3 \times 3} & {0}_{3 \times 3} \\ {0}_{3 \times 3} & {0}_{3 \times 3} & - {C ( {}_{G}^{I} \hat{q} )}^{T} & {0}_{3 \times 3} \\ {0}_{3 \times 3} & {0}_{3 \times 3} & {0}_{3 \times 3} & {I}_{3}\end{matrix} ) \\ {n}_{I}^{T} = {( \begin{matrix}{n}_{g}^{T} & {n}_{wg}^{T} & {n}_{a}^{T} & {n}_{wa}^{T}\end{matrix} )}^{T} \qquad [ Equation 5 ]$$

In step S220, the apparatus of the present disclosure acquires a position and pose of the depth camera mounted on the mobile robot at a prediction time based on the position and pose of the IMU predicted through the spline interpolation and the motion equation of the IMU, and by utilizing a positional relationship between the IMU and the depth camera, and may include the position and pose of the depth camera in the state variable of the MSCKF as Equation 6 below.

$${}_{G}^{C} \hat{q} = {}_{I}^{C} \hat{q} ⊗ {}_{G}^{I} \hat{q} , {}_{}^{G} {\hat{p}}_{C}^{} = {}_{}^{G} {\hat{p}}_{I}^{} + {C ( {}_{G}^{I} \hat{q} )}^{T} {}_{}^{I} {\hat{p}}_{C}^{} \qquad [ Equation 6 ]$$

At this point, the additional state variable for the position and pose of the depth camera is reflected in the covariance matrix of the state variable, as Equations 7 and 8, to represent a correlation with the existing state variable.

$${P}_{k \vert k} = ( \begin{matrix}{I}_{21 + 6 N} \\ J\end{matrix} ) {P}_{k \vert k} = {( \begin{matrix}{I}_{21 + 6 N} \\ J\end{matrix} )}^{T} \qquad [ Equation 7 ]$$

$$J = ( \begin{matrix}C ( {}_{I}^{C} \hat{q} ) & {0}_{3 \times 9} & {0}_{3 \times 3} & {I}_{3} & {0}_{3 \times 3} \\ - {C ( {}_{G}^{I} \hat{q} )}^{T} ⌊ {}^{I} {q}_{C \times } ⌋ & {0}_{3 \times 9} & {I}_{3} & {0}_{3 \times 3} & C ( {}_{G}^{I} \hat{q )}\end{matrix} ) \qquad [ Equation 8 ]$$

In step S220, the apparatus of the present disclosure may omit a bias-related term of the IMU included in the multi-state constraint Kalman filter (MSCKF) by using the spline interpolation, compared to the existing filter that does not use the spline interpolation, and thus may also reduce a time for a filter to estimate a pose of the mobile robot and estimate the pose of the mobile robot that is smooth due to characteristics of the spline interpolation.

In step S230, the visual-inertial odometry estimation apparatus (more precisely, the estimator 520 of the visual-inertial odometry estimation apparatus 500 according to the embodiment of the present disclosure) may estimate updated RGB-D visual-inertial odometry by applying the nonholonomic constraint and zero-velocity update (ZUPT) to the mobile robot equipped with the depth camera and IMU.

In step S230, the apparatus of the present disclosure may calculate and update the optimal state variable and covariance of the MSCKF by using the image pixel coordinate and the inverse depth information of the feature points acquired from the depth camera as the measurement value of the MSCKF.

The measurement uncertainty of the inverse depth information λ=1/d_{z} corresponding to the depth measurement value d_{z} of the feature point may be modeled as Equation 9.

$${σ}_{λ} = \frac{{σ}_{d}}{fb} \qquad [ Equation 9 ]$$

Here, σ_{d} represents the subpixel of the depth camera, f represents the focal length, and b represents the baseline between the RGB camera of the depth camera and the IR projector.

The measurement model of the MSCKF may be represented as Equation 10 through pixel coordinates and inverse depth information acquired from an image with respect to the feature point.

$$\begin{matrix}{z}_{i}^{j} = ( \begin{matrix}{u}_{i}^{j} \\ {v}_{i}^{j} \\ \frac{1}{{d}_{i}^{j}}\end{matrix} ) = ( \begin{matrix}{u}_{i}^{j} \\ {v}_{i}^{j} \\ \frac{1}{{}_{}^{{C}_{i}} {Z}_{j}^{}}\end{matrix} ) \\ = ( \begin{matrix}\frac{1}{{}_{}^{{C}_{i}} {Z}_{j}^{}} & 0 & 0 \\ 0 & \frac{1}{{}_{}^{{C}_{i}} {Z}_{j}^{}} & 0 \\ 0 & 0 & \frac{1}{{}_{}^{{C}_{i}} {Z}_{j}^{}}\end{matrix} ) ( \begin{matrix}{}_{}^{{C}_{i}} {X}_{j}^{} \\ {}_{}^{{C}_{i}} {Y}_{j}^{} \\ 1\end{matrix} )\end{matrix} \qquad [ Equation 10 ]$$

At this time, the optimal state variable and covariance of the MSCKF may be computed based on a difference between the actual measurement value for the same feature point and a predicted measurement value from the real-time position and pose of the mobile robot estimated by the MSCKF.

$${r}^{j} = {H}_{x}^{j} \tilde{x} + {H}_{f}^{j} {}_{}^{G} {\tilde{p}}_{j}^{} + {n}^{j} \\ K = {{PH}^{T} ( {HPH}^{T} + {R}_{n} )}^{- 1} \\ Δ x = Kr \\ {P}_{k + 1 \vert k + 1} = ( I - KH ) {{P}_{k + 1 \vert k + 1} ( I - KH )}^{T} + {KR}_{n} {K}^{T} \qquad [ Equation 11 ]$$

In general, the uncertainty of inverse depth used for robot correction is not modeled, making it difficult to assess the reliability of the corresponding depth information. As a result, when calculating a global position of a feature point corresponding to the inverse depth information, unreliable inverse depth information may degrade the accuracy of the position estimation. On the other hand, in step S230, the apparatus of the present disclosure is configured to model the uncertainty of the inverse depth information and prioritize more reliable data when calculating the global position of the feature point, thereby enabling more accurate pose correction of the mobile robot.

In step S240, the visual-inertial odometry estimation apparatus according to the embodiment of the present disclosure (more precisely, the estimator 520 of the visual-inertial odometry estimation apparatus 500 according to the embodiment of the present disclosure) may update the visual-inertial odometry based on the nonholonomic constraint (NHC) and the zero-velocity update (ZUPT).

Referring to FIG. 4, in step S240, the apparatus of the present disclosure utilizes the nonholonomic constraint (NHC) due to the motion characteristic of the differential-wheeled mobile robot 410, and thus the y-axis direction and the z-axis direction velocity of the mobile robot 410 with respect to the robot's body center OB are zero.

$${v}_{{B}_{y}} \approx {v}_{{B}_{z}} \approx 0 \qquad [ Equation 12 ]$$

Since the state variable of the MSCKF predicts the state in the IMU reference coordinate system, when the center of the body of the mobile robot 410 and the IMU do not coincide with each other, the velocity of the body of the mobile robot 410 may be represented as the velocity of the IMU reference coordinate system through Equation 13.

$${v}_{I} = C ( {}_{B}^{I} q ) {v}_{B} - ⌊ \hat{ω} \times ⌋ {r}^{I} \qquad [ Equation 13 ]$$

The error-state of the body reference velocity of the mobile robot 410 is represented as Equation 14 below.

$${\tilde{v}}_{B} = C ( {}_{B}^{I} q ) {}_{}^{G} {\tilde{v}}_{I}^{} - C ( {}_{B}^{I} q ) ⌊ {}_{}^{G} {\tilde{v}}_{I}^{} \times ⌋ {}_{G}^{I} \tilde{θ} \qquad [ Equation 14 ]$$

In step S240, the apparatus of the present disclosure may update the state variable of the MSCKF as follows by using a virtual 2D vector having zero-velocity as a measurement value in the y-axis and the z-axis directions of the body frame of the mobile robot 410.

$${z}_{n} = ( \begin{matrix}0 \\ 0\end{matrix} ) - {M}_{n} C ( {}_{B}^{I} q ) {}_{}^{G} {\tilde{v}}_{I}^{} = {H}_{n} \tilde{x} + {n}_{n} \qquad [ Equation 15 ]$$

$${M}_{n} = ( \begin{matrix}0 & 1 & 0 \\ 0 & 0 & 1\end{matrix} ) \\ {H}_{n} = ( - {M}_{n} C ( {}_{B}^{I} q ) ⌊ {}_{}^{G} {v}_{I}^{} \times ⌋ {0}_{2 \times 3} {M}_{n} C ( {}_{B}^{I} q ) {0}_{2 \times ( 15 + 6 N )} ) \qquad [ Equation 16 ]$$

In step S240, when the mobile robot is determined to be stationary, the apparatus of the present disclosure may update the state variable of the MSCKF using a virtual measurement value, in which the body frame velocities along the x-axis, y-axis, and z-axe directions of the mobile robot are zero.

$${v}_{{B}_{x}} \approx {v}_{{B}_{y}} \approx {v}_{{B}_{z}} \approx 0 \\ {z}_{n} = ( \begin{matrix}0 \\ 0 \\ 0\end{matrix} ) - {M}_{z} C ( {}_{B}^{I} q ) {}_{}^{G} {\tilde{v}}_{I}^{} = {H}_{z} \tilde{x} + {n}_{z} \qquad [ Equation 17 ]$$

$${M}_{z} = ( \begin{matrix}1 & 0 & 0 \\ 0 & 1 & 0 \\ 0 & 0 & 1\end{matrix} ) \\ {H}_{z} = ( - {M}_{z} C ( {}_{B}^{I} q ) ⌊ {}_{}^{G} {v}_{I}^{} \times ⌋ {0}_{2 \times 3} {M}_{z} C ( {}_{B}^{I} q ) {0}_{2 \times ( 15 + 6 N )} ) \qquad [ Equation 18 ]$$

Due to this, the apparatus of the present disclosure may prevent the mobile robot from having a physically infeasible velocity value due to the structural characteristics of the mobile robot, and thus improve the accuracy of the state estimation by using the nonholonomic constraint in step S240 compared to the conventional MSCKF-based visual-inertial state estimation technique.

FIG. 5 is a block diagram illustrating a detailed configuration of a visual-inertial odometry estimation apparatus according to an embodiment of the present disclosure.

Referring to FIG. 5, a visual-inertial odometry estimation apparatus according to an embodiment of the present disclosure is configured to calculate a prediction value of MSCKF using spline interpolation, and estimate an improved visual-inertial odometry through the nonholonomic constraint (NHC) and zero-velocity update (ZUPT) in a differential-wheeled mobile robot equipped with a depth camera and an inertial sensor.

To this end, the visual-inertial odometry estimation apparatus 500 according to an embodiment of the present disclosure includes a calculator 510 and an estimator 520. In this case, the calculator 510 may include a predictor 511 and a computer 512, and the estimator 520 may include a covariance handler 521 and a visual-inertial odometry updater 522.

Each of the predictor 511, the computer 512, the estimator 520, and the covariance handler 521 may be a set of at least one instruction and data that can be processed by a processor.

The calculator 510 calculates a state variable of a multi-state constraint Kalman filter (MSCKF) through the spline interpolation representing a trajectory of the mobile robot over time.

To explain the calculator 510 more specifically, the predictor 511 may predict a real-time position and pose of the mobile robot through the spline interpolation and utilize the predicted position and pose as the state variable of the MSCKF. The predictor 511 may use a position of the mobile robot on a plurality of previous (or past) key frames and a velocity vector calculated using a measurement value of the IMU acquired in real time, and may represent a trajectory of the mobile robot over time using the spline interpolation, and through this, the real-time position and posture of the mobile robot may be predicted and used as the state variable prediction value of the MSCKF.

More specifically, the predictor 511 may represent the trajectory of the mobile robot over time by the spline interpolation using a position Pk of the mobile robot acquired from a plurality of previous key frames and a velocity vector Gvk estimated from the latest key frame in real time as a constraint. At this time, a real-time position and pose of the mobile robot at the prediction time may be predicted using the spline interpolation, and the predicted real-time position and pose of the mobile robot may be used as the relative variable prediction value of the MSCKF.

As described above, the predictor 511 is configured to use a spline interpolation considering the speed constraint compared to existing filters that do not use a spline interpolation, thereby reducing errors in a filter update process based on a visual feature and allowing motion estimation similar to an actual movement of the mobile robot.

The computer 512 may compute a position and pose of the depth camera through the position and pose of the mobile robot.

The computer 512 is configured to compute the position and pose of the depth camera mounted on the mobile robot through the predicted real-time position and real-time pose of the mobile robot and derive a correlation between it and a previous position and pose of the depth camera. In this case, the computer 512 is configured to acquire a position and pose of the depth camera mounted on the mobile robot at a prediction time based on a position and pose of the IMU predicted through the spline interpolation and the motion equation of the IMU, and by utilizing a positional relationship between the IMU and the depth camera, and include the position and pose of the depth camera in the state variable of the MSCKF.

Due to this, the computer 512 is configured to omit a bias-related term of the IMU included in a multi-state constraint Kalman filter (MSCKF) by using a spline interpolation method, compared to the existing filter that does not use the spline interpolation, and thus also reduce a time for a filter to estimate a pose of the mobile robot and estimate a pose of the mobile robot that is smooth due to characteristics of the spline interpolation.

The estimator 520 is configured to estimate updated RGB-D visual-inertial odometry by applying nonholonomic constraint and zero-velocity update (ZUPT) to the mobile robot equipped with the depth camera and IMU.

To describe the estimator 520 in more detail, the covariance handler 521 is configured to calculate and update the optimal state variable and covariance of the MSCKF by using the image pixel coordinate and the inverse depth information of the feature points acquired from the depth camera as the measurement value of the MSCKF. In this case, the covariance handler 521 is configured to calculate the optimal MSCKF state variable and covariance based on a difference between the actual measurement value for the same feature point acquired from the depth camera and the predicted measurement value estimated from the real-time position and pose of the mobile robot, and model the uncertainty of the inverse depth information and prioritize more reliable data when calculating the global position of the feature point, thereby enabling more accurate pose correction of the mobile robot.

The visual-inertial odometry updater 522 may update the visual-inertial odometry based the nonholonomic constraint (NHC) and the zero-velocity update (ZUPT).

The visual-inertial odometry updater 522 may update the state variable of the MSCKF by using the nonholonomic constraint that assumes zero-velocity in the y-axis and z-axis directions of the mobile robot's body frame, and applying a virtual 2D vector as a measurement value. In addition, when the mobile robot is determined to be stationary, the visual-inertial odometry updater 522 is configured to update the state variable of the MSCKF using a virtual measurement value generated by the zero-velocity update (ZUPT), in which the body frame velocities along the x-axis, y-axis, and z-axe directions of the mobile robot are zero.

Although the description is omitted from the apparatus of FIG. 5, each component constituting FIG. 5 may include all of the contents described with reference to FIGS. 1 to 4, which is obvious to those skilled in the art.

The system or the apparatus described above may be implemented as a hardware component, a software component, and/or a combination of hardware and software components. For example, the apparatuses and components described in the embodiments may be implemented using one or more general-purpose or special-purpose computers, such as, for example, a processor, a controller, an arithmetic logic unit (ALU), a digital signal processor, a microcomputer, a field programmable gate array (FPGA), a programmable logic unit (PLU), a microprocessor, or any other apparatus capable of executing and responding to instructions. The processing apparatus may perform an operating system (OS) and one or more software applications performed on the operating system. In addition, the processing apparatus may access, store, manipulate, process, and generate data in response to execution of the software. For convenience of understanding, the processing apparatus may be described as being used in one, but those skilled in the art will appreciate that the processing apparatus may include a plurality of processing elements and/or a plurality of types of processing elements. For example, the processing apparatus may include a plurality of processors or one processor and one controller. In addition, other processing configurations such as parallel processors may be used.

Software may include a computer program, a code, an instruction, or a combination of one or more of them, and may configure the processing apparatus to operate as desired or may independently or collectively command the processing apparatus. Software and/or data may be permanently or temporarily embodied in any type of machine, component, physical apparatus, virtual equipment, computer storage medium or apparatus, or transmitted signal wave to be interpreted by the processing apparatus or to provide instructions or data to the processing apparatus. Software may be distributed on a computer system connected by a network, and may be stored or executed in a distributed manner. Software and data may be stored in one or more computer-readable recording media.

The method according to the embodiment may be implemented in the form of program instructions that may be performed by various computer means and recorded in a computer-readable medium. The computer-readable medium may include program instructions, data files, data structures, and the like, alone or in combination. The program instructions recorded in the medium may be specially designed and configured for the embodiment or may be known and usable to those skilled in the art of computer software. Examples of the computer-readable recording media include a hard disk, a magneto-optical media, a solid-state drive (SSD), and a hardware apparatus specially configured to store and perform program instructions such as a read-only memory (ROM), a random access memory (RAM), a flash memory, and the like. Examples of the program instructions include not only machine language codes such as those made by a compiler but also higher-level language codes that may be executed by a computer using an interpreter. The above-described hardware apparatus may be configured to operate as one or more software modules to perform the operations of the embodiment, and vice versa.

Although the embodiments have been described by the limited embodiments and the drawings, various modifications and variations may be made from the above descriptions by those skilled in the art. For example, a suitable result may be achieved even if the described techniques are performed in a different order than the described method, and/or components such as the described system, structure, apparatus, circuit, etc., are combined or substituted in a different form than the described method, or replaced or substituted by other components or equivalents.

Therefore, other implementations, other embodiments, and equivalents to the claims fall within the scope of the following claims.

What is claimed is:

1. A method for estimating a multi-state constraint Kalman filter (MSCKF) based RGB-D visual-inertial odometry with a spline interpolation and a nonholonomic constraint (NHC) performed by a computer, comprising:
calculating a state variable of the MSCKF through the spline interpolation representing a trajectory of a mobile robot over time; and
estimating an updated RGB-D visual-inertial odometry using the nonholonomic constraint (NHC) and a zero-velocity update (ZUPT) in the mobile robot equipped with a depth camera and an inertial sensor mounted thereon.

2. The method of claim 1, wherein the calculating the state variable of the MSCKF comprises:
predicting a real-time position and pose of the mobile robot through the spline interpolation and utilizing the predicted real-time position and pose as the state variable of the MSCKF; and
calculating a position and pose of the depth camera based on the position and pose of the mobile robot.

3. The method of claim 2, wherein the predicting the real-time position and pose of the mobile robot and utilizing them as the state variable of the MSCKF comprises:
representing the trajectory of the mobile robot over time by the spline interpolation using a position of the mobile robot acquired from a plurality of previous key frames and a velocity vector estimated from a latest key frame in real time as a constraint.

4. The method of claim 3, wherein the predicting the real-time position and pose of the mobile robot and utilizing them as the state variable of the MSCKF comprises:
predicting the real-time position and pose of the mobile robot at a prediction time using the spline interpolation and using the predicted real-time position and pose as a relative variable prediction value of the MSCKF.

5. The method of claim 4, wherein the calculating the position and pose of the depth camera comprises:
calculating the position and pose of the depth camera mounted on the mobile robot based on the predicted real-time position and pose of the mobile robot and deriving a correlation between it and a previous position and pose of the depth camera.

6. The method of claim 5, wherein the calculating the position and pose of the depth camera comprises:
acquiring the position and pose of the depth camera mounted on the mobile robot at the prediction time based on the position and pose of an IMU predicted through the spline interpolation and a motion equation of the IMU and by utilizing a positional relationship between the IMU and the depth camera.

7. The method of claim 1, wherein the estimating the updated RGB-D visual-inertial odometry comprises:
calculating an optimal state variable and covariance of the MSCKF by utilizing an image pixel coordinate and inverse depth information of feature points acquired from the depth camera as a measurement value of the MSCKF; and
updating the visual-inertial odometry based on the nonholonomic constraint (NHC) and the zero-velocity update (ZUPT).

8. The method of claim 7, wherein the calculating the optimal state variable and covariance of the MSCKF comprises:
calculating the optimal state variable and covariance of the MSCKF based on a difference between an actual measurement value for a same feature point and a predicted measurement value from the real-time position and pose of the mobile robot estimated by the MSCKF.

9. The method of claim 7, wherein the updating the visual-inertial odometry comprises:
updating the state variable of the MSCKF by using the nonholonomic constraint that assumes zero-velocity in y-axis and z-axis directions of the mobile robot's body frame, and applying a virtual 2D vector as a measurement value.

10. The method of claim 9, wherein the updating the visual-inertial odometry comprises:
updating the state variable of the MSCKF using a virtual measurement value generated by the zero-velocity update (ZUPT), in which the body frame velocities along x-axis, y-axis, and z-axe directions of the mobile robot are zero when the mobile robot is determined to be stationary.

11. An apparatus for estimating a multi-state constraint Kalman filter (MSCKF) based RGB-D visual-inertial odometry with a spline interpolation and a nonholonomic constraint (NHC), comprising:
a calculator configured to calculate a state variable of the MSCKF through the spline interpolation representing a trajectory of a mobile robot over time; and
an estimator configured to estimate an updated RGB-D visual-inertial odometry using the nonholonomic constraint (NHC) and a zero-velocity update (ZUPT) in the mobile robot equipped with a depth camera and an inertial sensor mounted thereon.

12. The apparatus of claim 11, wherein the calculator comprises:
a predictor configured to predict a real-time position and pose of the mobile robot through the spline interpolation and utilizing the predicted real-time position and pose as the state variable of the MSCKF; and
a computer configured to compute a position and pose of the depth camera based on the position and pose of the mobile robot.

13. The apparatus of claim 12, wherein the predictor is configured to represent the trajectory of the mobile robot over time by the spline interpolation using a position of the mobile robot acquired from a plurality of previous key frames and a velocity vector estimated from a latest key frame in real time as a constraint.

14. The apparatus of claim 13, wherein the predictor is configured to predict the real-time position and pose of the mobile robot at a prediction time using the spline interpolation and using the predicted real-time position and pose as a relative variable prediction value of the MSCKF.

15. The apparatus of claim 14, wherein the computer is configured to compute the position and pose of the depth camera mounted on the mobile robot based on the predicted real-time position and pose of the mobile robot and deriving a correlation between it and a previous position and pose of the depth camera.

16. The apparatus of claim 15, wherein the computer is configured to acquire the position and pose of the depth camera mounted on the mobile robot at the prediction time based on the position and pose of an IMU predicted through the spline interpolation and a motion equation of the IMU and by utilizing a positional relationship between the IMU and the depth camera.

17. The apparatus of claim 11, wherein the estimator comprises:
a covariance handler configured to calculate an optimal state variable and covariance of the MSCKF by utilizing an image pixel coordinate and inverse depth information of feature points acquired from the depth camera as a measurement value of the MSCKF; and
a visual-inertial odometry updater configured to update the visual-inertial odometry based on the nonholonomic constraint (NHC) and the zero-velocity update (ZUPT).

18. The apparatus of claim 17, wherein the covariance handler is configured to calculate the optimal state variable and covariance of the MSCKF based on a difference between an actual measurement value for a same feature point acquired from the depth camera and a predicted measurement value from the real-time position and pose of the mobile robot.

19. The apparatus of claim 17, wherein the visual-inertial odometry updater is configured to update the state variable of the MSCKF by using the nonholonomic constraint that assumes zero-velocity in y-axis and z-axis directions of the mobile robot's body frame, and applying a virtual 2D vector as a measurement value.

20. The apparatus of claim 19, wherein the visual-inertial odometry updater is configured to update the state variable of the MSCKF using a virtual measurement value generated by the zero-velocity update (ZUPT), in which the body frame velocities along x-axis, y-axis, and z-axe directions of the mobile robot are zero when the mobile robot is determined to be stationary.
